(19) United States
(12) Patent Application Publication
(10) Pub. No.: US 2002/0038308 A1
(43) Pub. Date: Mar. 28, 2002

(54) SYSTEM AND METHOD FOR CREATING A VIRTUAL DATA WAREHOUSE

(76) Inventor: MICHAEL CAPPI, NEW YORK, NY (US)

Correspondence Address: ROBERT M HARON, SOFFER & HARON LLP, 342 MADISON AVENUE SUITE 1921, NEW YORK, NY, 10173

(21) Appl. No.: 09/320,896

(22) Filed: May 27, 1999

(51) Int. Cl. G06F 7/00

(52) U.S. Cl. 707/104.1; 707/1

(57) ABSTRACT

A system and method for creating a global data dictionary from a plurality of databases such that users may conduct expansive searches or queries, and retrieve data therefrom, regardless of the database management system from each respective database. The global data dictionary is created by semantically and syntactically integrating data elements from the plurality of databases. The plurality of data elements are stored in a dictionary system, wherein each of the data elements corresponds to at least one data element in the plurality of databases. Relationships are identified between two or more of the data elements in the dictionary system. In order to retrieve data, upon receiving from a user a request for data in the form of a query data element, the system identifies the data elements in the dictionary system that corresponds to the query data element and retrieves the data corresponding to the query data element from the databases.

### FIELD OF THE INVENTION

This invention relates to database integration, and more particularly, to a software component for logically integrating multiple databases onto one global data dictionary so that users may conduct expansive searches or queries regardless of the database management system from each respective database or its physical location.

### BACKGROUND OF THE INVENTION

With the recent progression in information technology more sophisticated and efficient methods for storing, manipulating and retrieving information are becoming readily available. It is not surprising that perhaps more vital to a company or business today than any other asset is its data. Indeed, many entities operate for the exclusive purpose of supplying and manipulating necessary data for others.

One significant problem, however, is that with the continuous advancement in database and other related technologies it is often the case that different companies and even different departments within one company each use different database management systems to support their data. While accessing one's own data may be a simple task, it is quite another to integrate or compare that data with data from another Database management system. It is often necessary for companies to laboriously convert the multiple database formats to be compatible with each other.

For instance, when two or more databases in the prior art were desired to be accessed simultaneously as though they are a single logical entity by a user, each database was required to have been logically defined in terms of the same database management system. Unless each database was logically defined in terms of the same database management system, a request by a user for data from both databases would not retrieve data properly or would have to be accessed through each database management system separately

Previously, in order to enable a user to access data from two or more databases having different database management systems, the two or more databases desired to be accessed simultaneously were required to be physically joined. In order to accomplish this, a great deal of manual programming labor was required. In addition, the physical joining of two data bases can not be performed with data from two different companies, since each company typically considers its own database to be proprietary.

Another solution to the problem was to perform specific ad hoc programming in order to reprogram the database management systems of each database so that they are identical. Again, a great deal of manual programming labor is required in order to accomplish this, because there is no system in the prior art that has “smart” integration. In other words, unless each data element is manually converted and/or related, there is no prior art system that can integrate databases and link similar data elements together. For example, ‘revenue’ from one database may describe the same entity as ‘earnings’ from another database, but this relationship is not recognized because the data elements in each database are different.

Thus, there is a need for a database system or software component for integrating multiple databases onto one platform so that users may conduct expansive searches or queries regardless of the database management system from each respective database or the number of databases.

### OBJECT AND SUMMARY OF THE INVENTION

It is thus a general object of the present invention to provide a database system or software component for syntactically and semantically integrating multiple databases into a single logical entity accessible through one global data dictionary so that users may conduct expansive searches or queries regardless of the database management system from each respective database.

The present invention, in accordance with one embodiment, relates to a system and method for creating a global data dictionary that permits retrieval of data from a plurality of databases. In a first step, the method stores in a dictionary system (also called a Global Data Dictionary) a plurality of data elements, wherein each of the data elements may correspond to at least one data element in the plurality of databases. The method next identifies relationships between two or more of the data elements in the dictionary system. Upon receiving from a user a request for data in the form of a query data element, the system identifies the data elements in the dictionary system that corresponds semantically to the query data element and retrieves the data from each of the data elements of the databases corresponding to the query data element.

In accordance with a preferred embodiment, the method further comprises the step of storing the plurality of data elements in a data element dictionary. The data element dictionary is advantageously configured to identify each database that the data elements are found in. The method may also comprise the step of storing a plurality of keywords in a master keyword dictionary. The plurality of keywords comprises a list of every data element from the plurality of databases and also comprises a group of industry words which a user may employ in performing a search of the databases. Each keyword has a synonym set, which comprises a plurality of words, such as data elements, that have a relationship with the keyword. Advantageously, the master keyword dictionary also comprises a weight representing the degree of similarity between each keyword and the words in its synonym set.

The above description sets forth rather broadly the more important features of the present invention in order that the detailed description thereof that follows may be understood, and in order that the present contributions to the art may be better appreciated. Other objects and features of the present invention will become apparent from the following detailed description considered in conjunction with the accompanying drawings. It is to be understood, however, that the drawings are designed solely for the purposes of illustration and not as a definition of the limits of the invention, for which reference should be made to the appended claims.

### DETAILED DESCRIPTION OF THE DRAWINGS

In the drawings in which like reference characters denote similar elements throughout the several views:

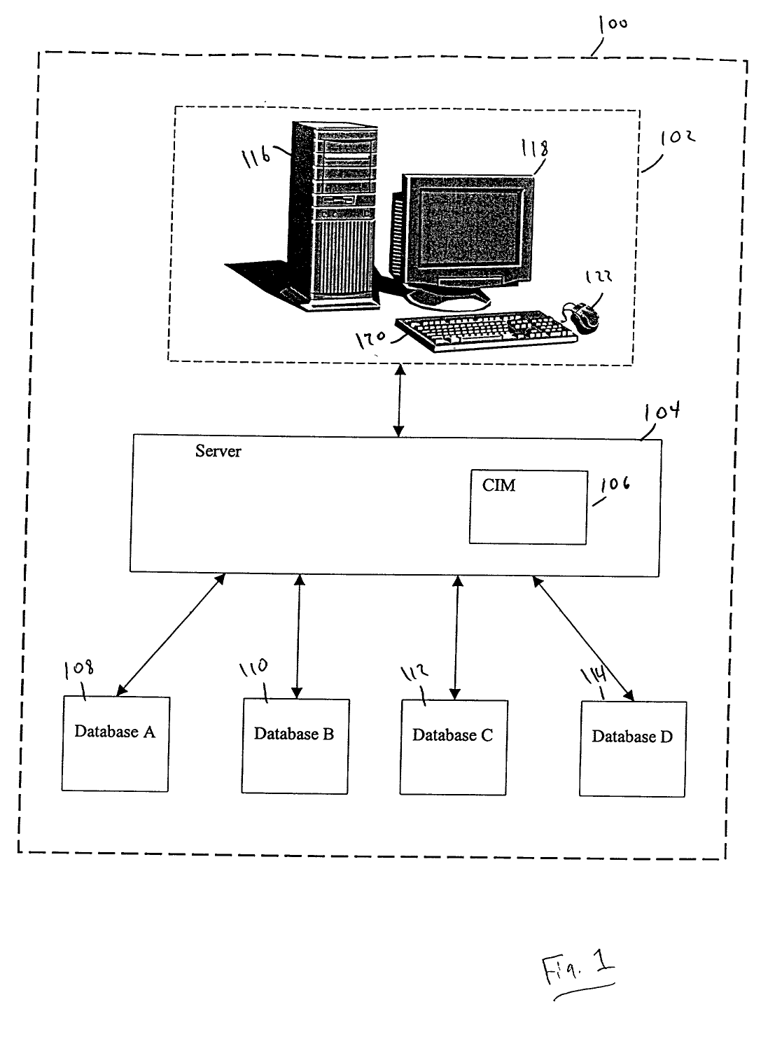

FIG. 1 illustrates the structure of the database system of this invention, according to one embodiment;

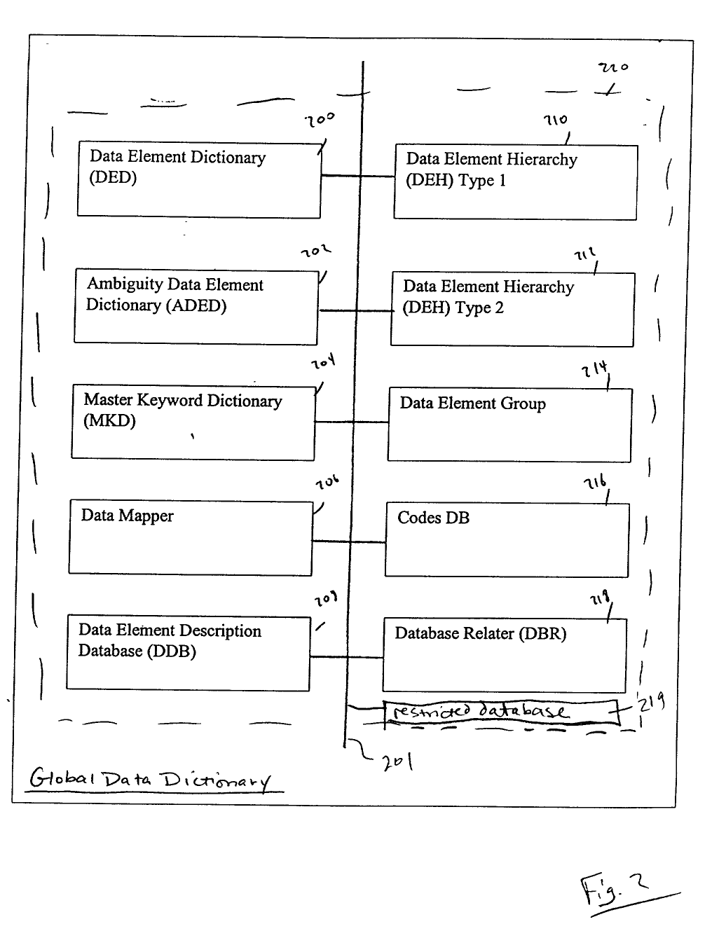

FIG. 2 illustrates the structure of the content integration model database system according to one embodiment of this invention;

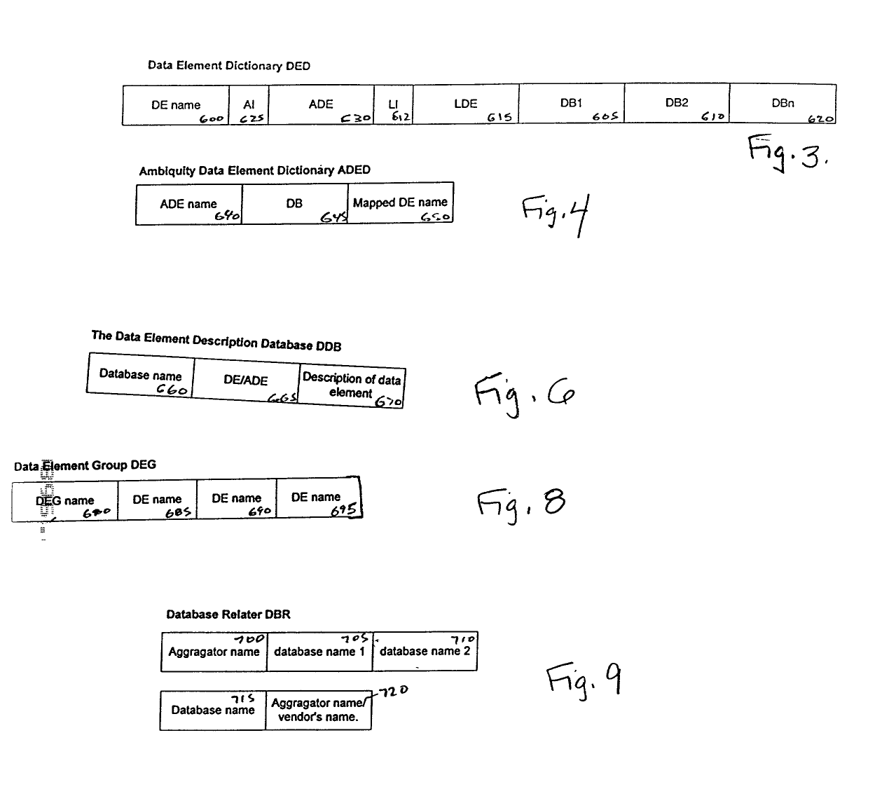

FIG. 3 is a diagram that illustrates the arrangement of data in a data element dictionary, according to one embodiment of the invention;

FIG. 4 is a diagram that illustrates the arrangement of data in an ambiguous data element dictionary, according to one embodiment of the invention;

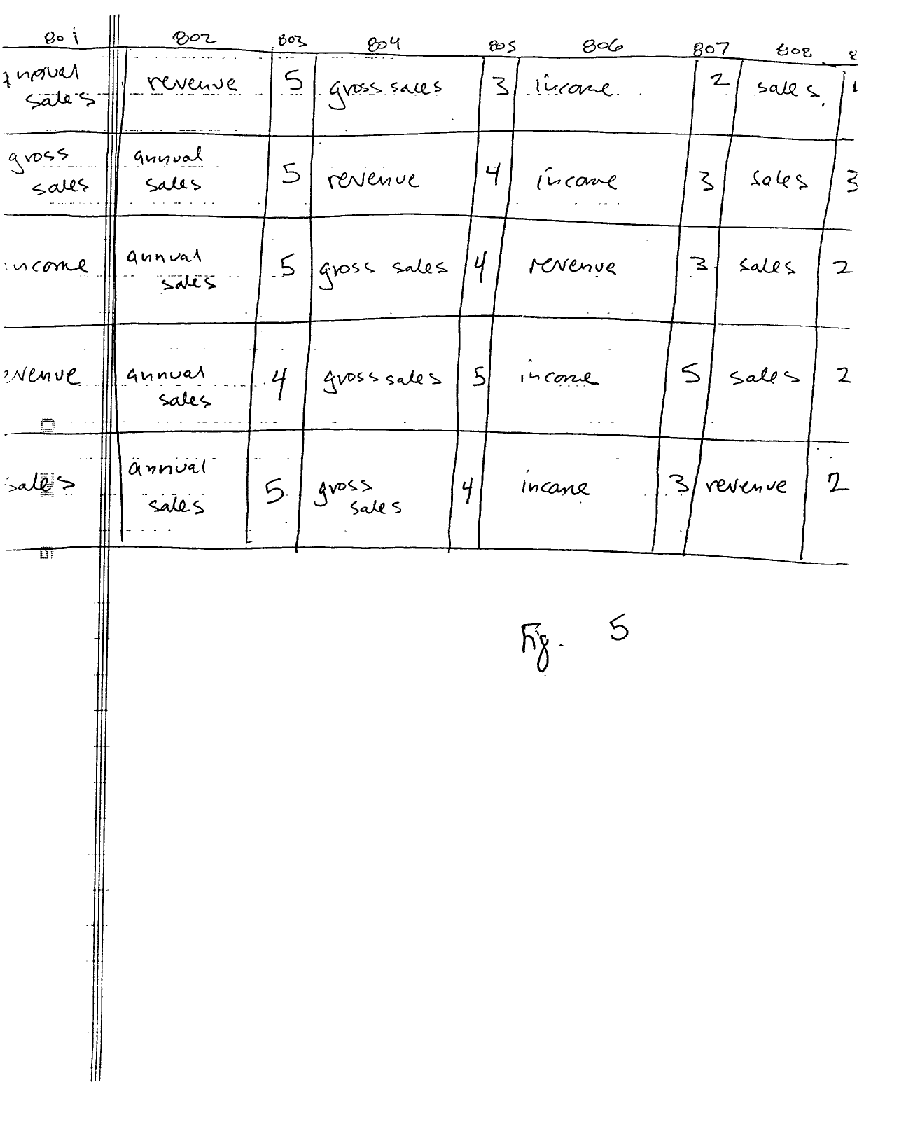

FIG. 5 illustrates an example of the arrangement of data in a master keyword dictionary component, in accordance with one embodiment of the present invention;

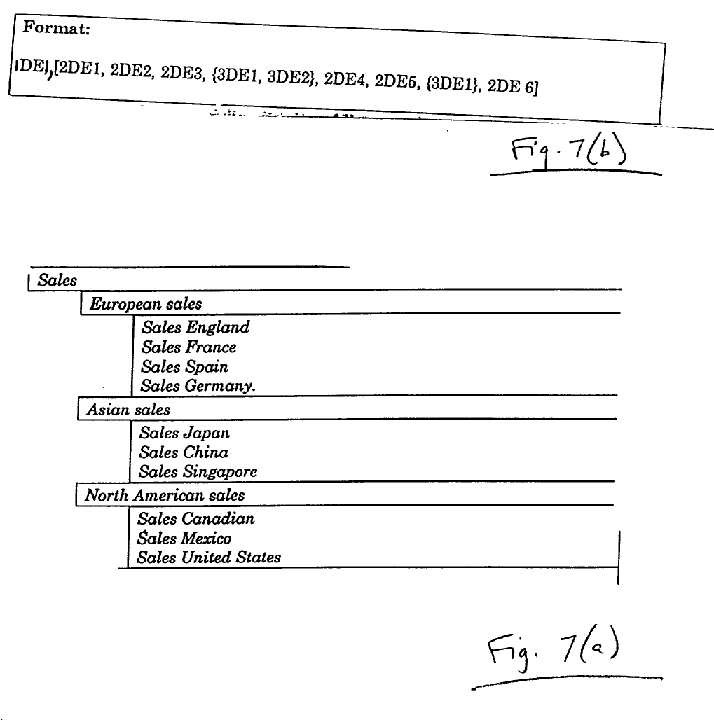

FIG. 6 is a diagram that illustrates the arrangement of data in a data element description database, according to one embodiment of the invention;

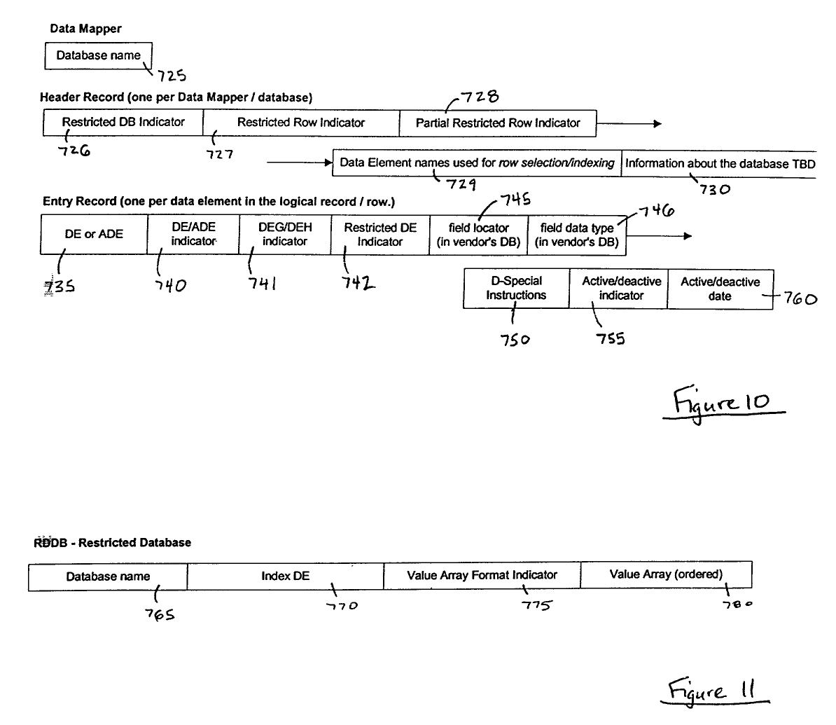

FIG. 7(a) illustrates the arrangement of data elements in a hierarchical relationship in a first data element hierarchy component, according to one embodiment of the present invention;

FIG. 7(b) illustrates the arrangement of data in a second data element hierarchy component, according to one embodiment of the invention;

FIG. 8 illustrates the arrangement of data in a data element group component, according to one embodiment of the invention;

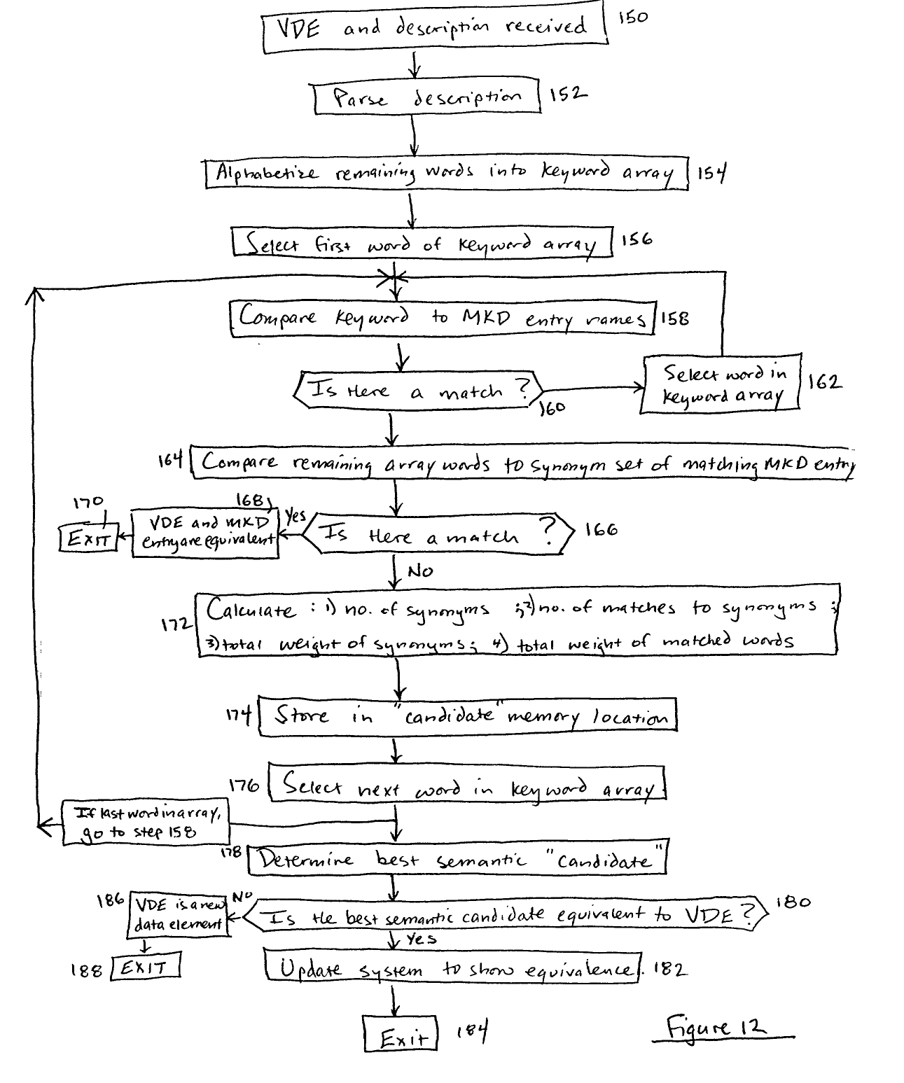

FIG. 9 is a diagram that illustrates the arrangement of data in a database relater component, according to one embodiment of the invention;

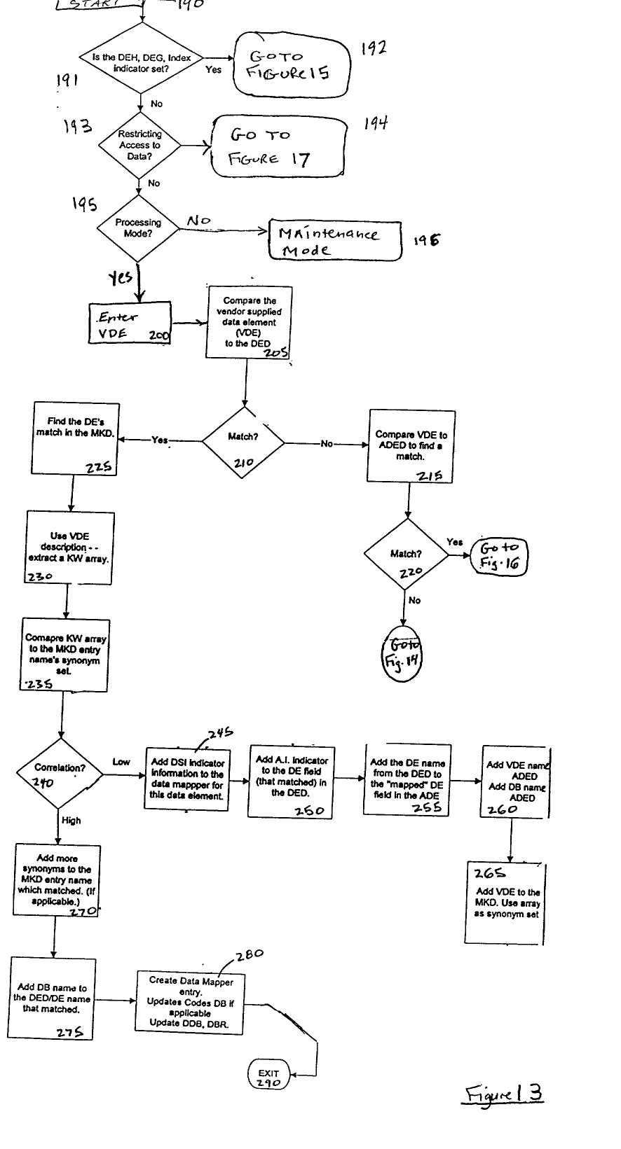

FIG. 10 is a diagram that illustrates the arrangement of data in a data mapper, according to one embodiment of the invention;

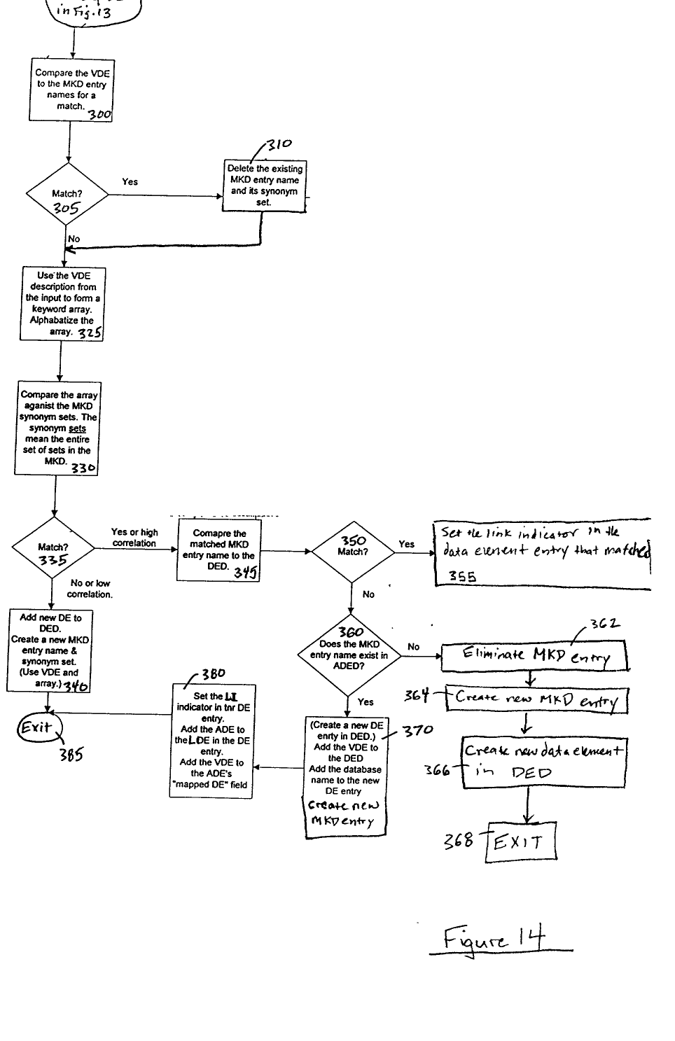

FIG. 11 is a diagram that illustrates the arrangement of data in a restricted database component, according to one embodiment of the invention;

FIG. 12 is a flow chart that illustrates steps performed by a correlation algorithm, in accordance with one embodiment of the invention;

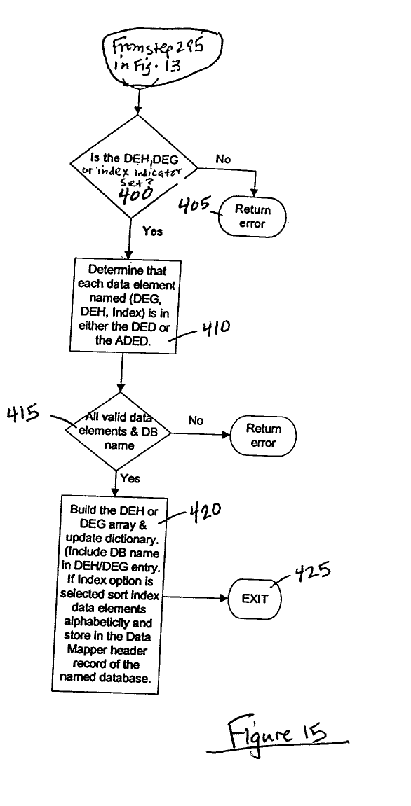

FIG. 13 is a flow chart that illustrates steps performed in order to integrate multiple databases, in accordance with one embodiment of the invention;

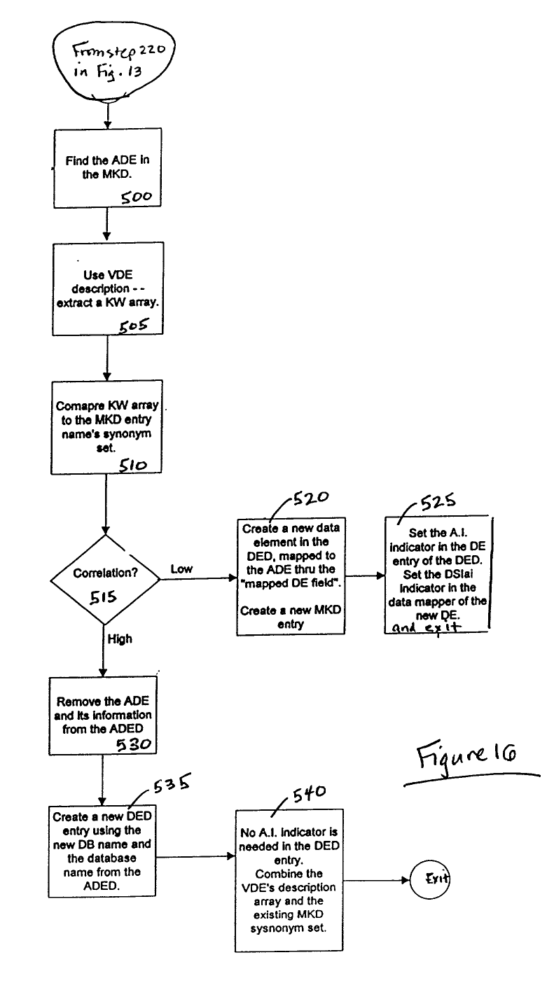

FIG. 14 is a flow chart that illustrates additional steps as performed by the system of the present invention, in accordance with one embodiment;

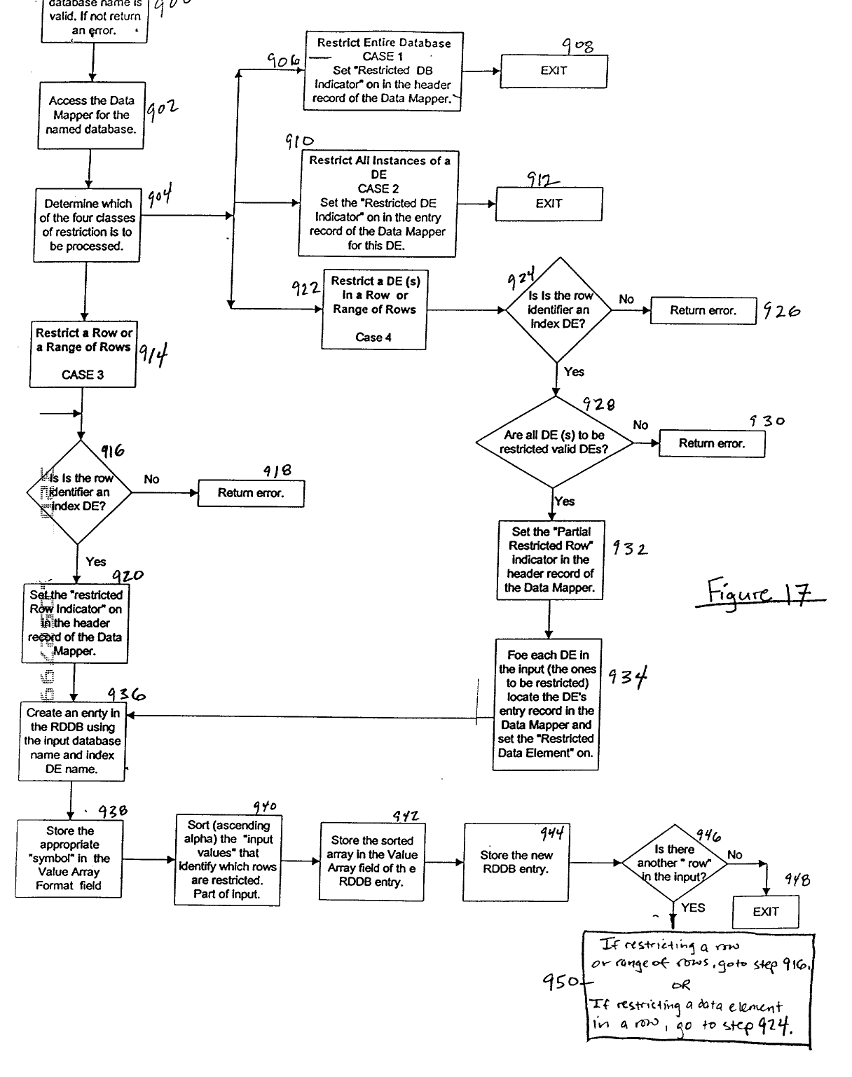

FIG. 15 is a flow chart that illustrates additional steps performed by the system of the present invention, according to one embodiment;

FIG. 16 is a flow chart that illustrates additional steps performed by the system of the present invention, according to one embodiment;

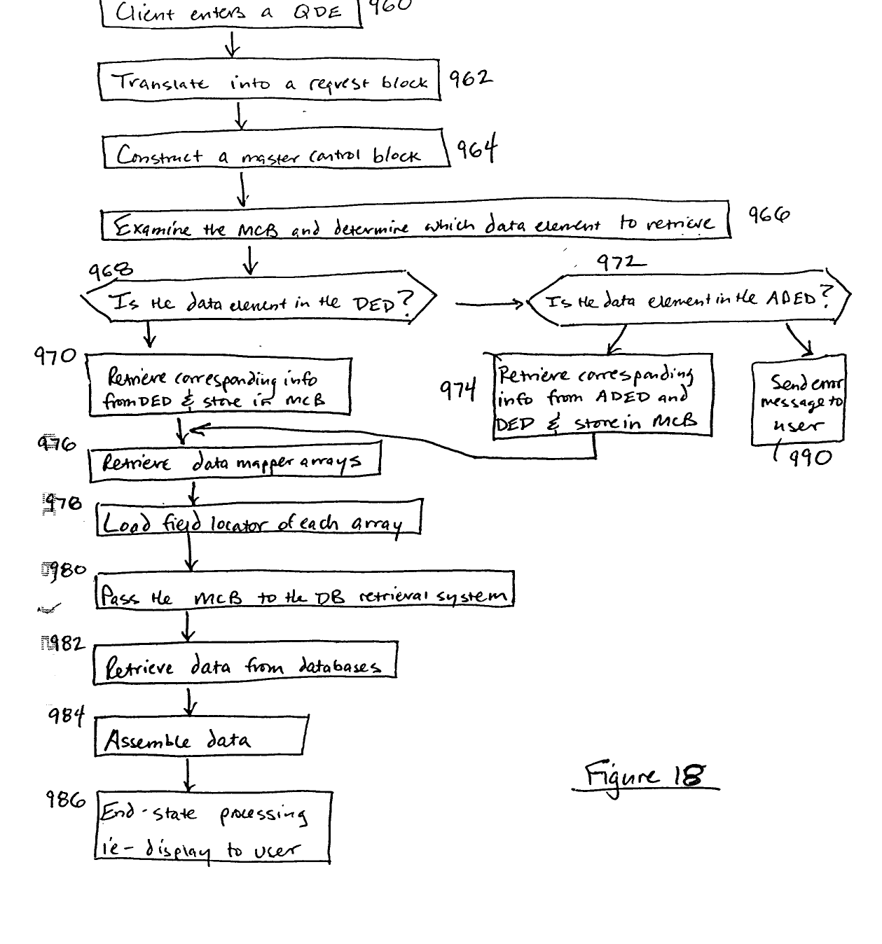

FIG. 17 is a flowchart that illustrates the steps performed by the system of the present invention to restrict the retrieval of data by some users, in accordance with one embodiment;

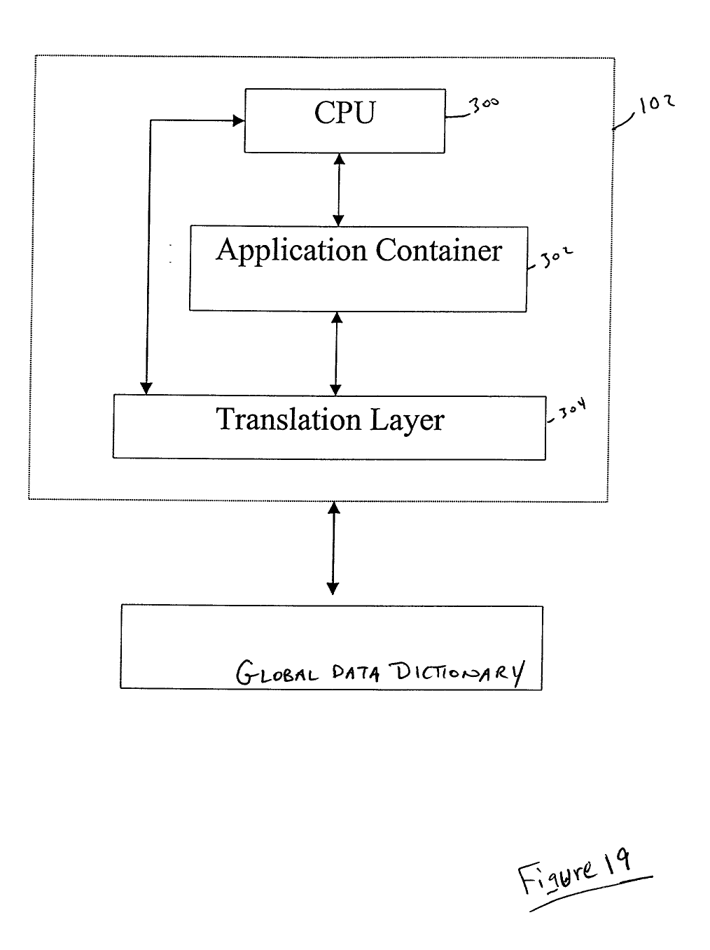

FIG. 18 is a flowchart that illustrates the steps performed by the system of the present invention to facilitate the retrieval of data from databases, in accordance with one embodiment;

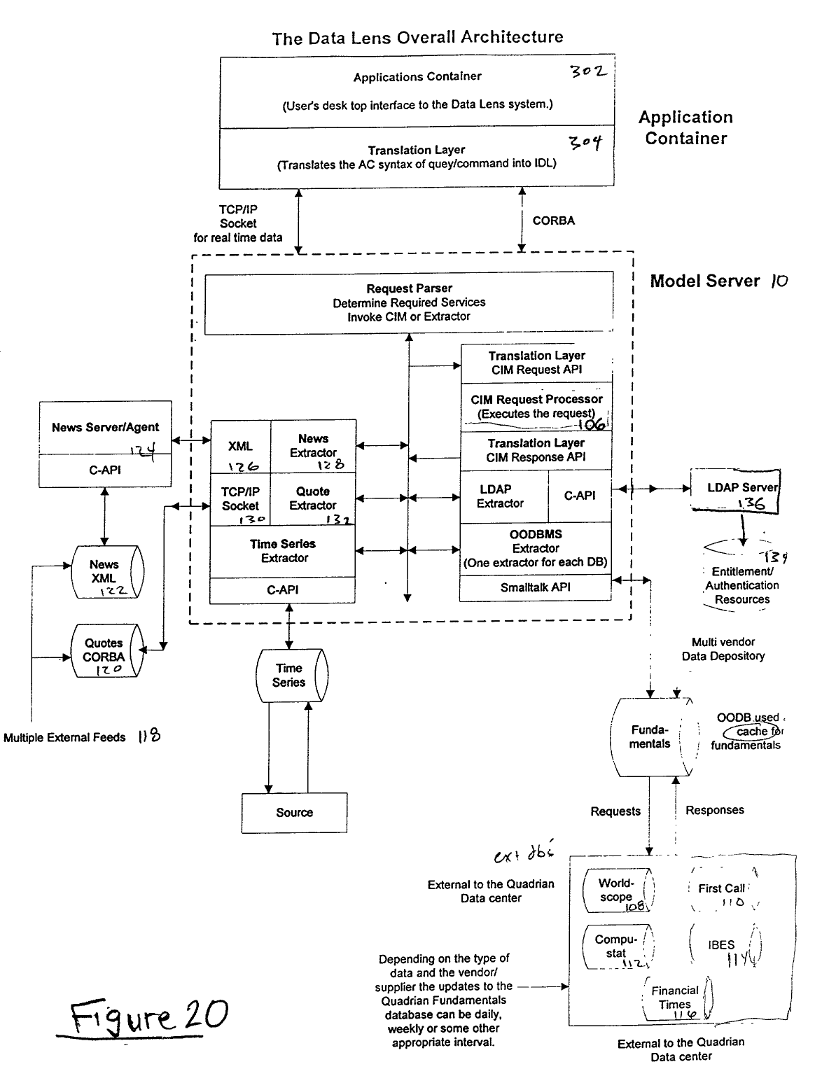

FIG. 19 is a block diagram of the application container and related components of this invention, according to one embodiment; and

FIG. 20 illustrates the overall architecture of the database system of this invention, according to one embodiment.

### DETAILED DESCRIPTION OF THE INVENTION

With reference to FIG. 1, a database system 100 is shown for enabling the logical integration of data elements across multiple databases onto one logical data dictionary, according to one embodiment of the present invention. Database system 100 comprises an interface computer system 102, a model server 104 and a plurality of external databases connected to model server 104, including in this embodiment database 108, database 110, database 112 and database 114.

Interface computer system 102 comprises a tower case 116 for housing various system components such as the CPU 300 (shown in FIG. 18), mainboard, memory and disk storage (not shown). Furthermore, computer system 102 comprises a display screen 118 so that an application, used for introducing new databases to the content integration manager, can provide a visual output to the user. Also provided is a keyboard 120 and mouse 122 to provide user input components to the computer system.

Server 104 is primarily configured to receive user instructions or other information from computer system 102 and process these requests via content integration manager 106. The output of the content integration manager is the global data dictionary. Server 104 and content integration manager 106 comprise various hardware and software components to facilitate this process.

With reference to FIG. 2, the global data dictionary is shown, comprising dictionary elements 200-219. These components include data element dictionary component 200, ambiguity data element dictionary component 202, master keyword dictionary component 204, data mapper component 206, data element description database component 208, data element hierarchy type 1 component 210, data element hierarchy type 2 component 212, data element group component 214, codes DB component 216 and database relater component 218. According to one embodiment, components 200-218 are also referred to as dictionary components.

According to one embodiment, the global data dictionary enables a computer user to simultaneously search, view, or analyze data from multiple databases each having the same or different database management system(s) without the need for ad hoc programming to link or join the dissimilar systems. The aforementioned dictionary components as well as other tools are utilized to establish relationships among the multiple databases to actually simulate one logically integrated database system. Thus, for example, even though two or more databases may have different database management systems, and would normally be incompatible, server 104 acts as an integration component to identify relationships between data elements from different databases and to employ these relationships to permit the databases to be accessed simultaneously. This process enables users to utilize multiple databases as if they were actually joined, but without physically joining them. It is understood that in an alternative embodiment one or more integrated database systems may optionally be physically joined as well.

According to one embodiment, the system of this invention accomplishes such a task via two stages: an integration stage and a retrieval stage.

Briefly, the first stage, the integration stage, involves loading the structure of individual source databases, such as databases 108-114 into server 104. This stage is performed once by the content integrtion manager for each source database system, wherein all data elements, keywords and any discovered relationships are stored so that model server 104 may permanently access it afterwards. Data elements, as commonly understood to those skilled in the art, refer to the names or identifiers of the underlying database tables and entries. Each data element comprises a description, which facilitates the creation of keywords and relationships. The process of creating keywords and relationships is performed via dictionary system 220 and will be explained in more detail below.

The second stage, the retrieval stage, is simply a user query or request that is processed by a model server, such as is shown in FIG. 20 (to be explained below). The retrieval stage is the application and use of the invention once two or more databases have been integrated. Logically, this query or request can only be executed against the finite number of source database systems previously loaded into model server 104 at stage one. Additional databases can be subsequently added to expand the number of databases accessible to the user.

Processing a user request involves accessing the global data dictionary created by content integration manager 106, wherein the relationships, keywords and data elements generated from the first stage are analyzed and compared with the query or request. Thereafter, one or more data elements are returned by content integration manager 106 and the corresponding source databases are accessed so that the underlying data corresponding to the returned data elements can be retrieved and sent to the user. This is different from a conventional user query in that the global data dictionary is employed to “understand” what the user is looking for and to determine which databases contain such information.

For example, a data element from database 108 may be titled “earnings,” whereby this data element may contain earnings data for various companies. Another data element from database 110 may be titled “income,” whereby this data element may also contain earnings data for various companies. Normally, without a programmer manually joining these data elements from each of the two databases the computer would not know that these fields are equivalent or even similar. The system of this invention, however, analyzes the two fields and establishes a relationship, using various semiautomatic methods such as description parsing, as will be explained below, such that these two fields are labeled as semantically equivalent. A user who subsequently conducts a search for either “income” or “earnings” would retrieve both these data elements from both databases since the dictionary system from this invention would have the relationship recorded. There are many other relationships across database systems that must be incorporated into content integration manager server during the integration stage. These include, differences and similarities among semantics, syntax, hierarchical relationships, groupings, etc., which will be described in more detail below.

FIG. 2 illustrates the various components of the global data dictionary, according to one embodiment of the present invention. Each component is shown as a separate memory location coupled to internal bus 201. It should also be noted that, although one embodiment of the invention is disclosed in the context of discrete functioning elements such as data element dictionary 200, master keyword dictionary 204, etc., it is understood that different discrete functioning elements or software could be employed to carry out the present invention.

With continued reference to FIG. 2, the components of dictionary system 220 operate as follows. The three primary dictionary components in the dictionary system are the data element dictionary component 200, the ambiguity data element dictionary component 202 and the master keyword dictionary component 204. These three dictionary components define the syntactic and semantic connections among data elements across all of the databases created by the content integration manager 106 component. There are also several support dictionary components which provide needed infrastructure to help in the process of both integrating new databases as well as searching out relationships and retrieving information during the operation of stage two, as will be explained in greater detail below.

Data element dictionary 200 and ambiguity data element dictionary 202 comprise all of the data elements from every integrated database defined to the system. Each data element in the dictionary (also referred to as a data element entry) is mapped to the corresponding original data element from the source database system so that the underlying data associated with that data element can be easily retrieved when requested by a user.

FIG. 3 is a diagram that illustrates the arrangement of data in data element dictionary 200, according to one embodiment of the invention. In this embodiment, data element dictionary 200 comprises a plurality of rows (only one row is shown), wherein each row corresponds to a data element. In each row, there are a plurality of fields. The first field of the row, designated as field 600, comprises the names of data elements, such as “revenue” or “income”. Fields 605 through 620 comprise identifiers of the databases where the data element in field 600 can be found.

Each row of data element dictionary 200 also comprises an ambiguity indicator in field 625, which alerts a search engine when there is a connection to a data element in ambiguous data element dictionary 202 (described below). Generally, an ambiguity indicator exists when there is another data element with the same name as the data element being processed, but which has a different meaning. The ambiguity indicator alerts the search engine to also look for corresponding matching data elements in ambiguity data element dictionary 202. If an ambiguity indicator is present in an entry, there may also be present an ambiguous data element name stored in field 630, which is the entry in ambiguity data element dictionary 202 that the data element is noted as being “ambiguously” related to.

For those data elements that are not “normalized” into the dictionary system, ambiguity data element dictionary 202 is used. A “normalized” data element is a data element that has been logically matched with other data elements in the dictionary system. The data elements that have not been normalized are placed in ambiguity data element dictionary 202, which temporarily stores the data element for further processing.

FIG. 4 is a diagram that illustrates the arrangement of data in ambiguous data element dictionary 202, according to one embodiment of the invention. In this embodiment, ambiguous data element dictionary 202 comprises a plurality of rows, wherein each row corresponds to an ambiguous data element. Ambiguity is described in greater detail below, but generally, a data element is “ambiguous” relative to another data element if the data elements have some things in common but other things that are not in common. This may occur when data elements have the same names but different meanings, or have different names but the same or similar meanings.

Returning to FIG. 4, in each row, there are a plurality of fields. The first field of the row, designated as field 640, comprises the ambiguous data element name. Field 645 comprises an identifier of the database where the ambiguous data element of field 640 can be found. Each row of ambiguous data element dictionary 202 also comprises a mapped data element name in field 650. The mapped data element name identifies the data element to which the ambiguous data element is “ambiguously” related.

It is important to note that, according to one embodiment, the ambiguous data elements are still subject to manipulation by content integration manager 106. When ambiguity data element dictionary 202 data elements are normalized they will be dropped from ambiguity data element dictionary 202 dictionary and placed in the data element dictionary component. Although some ambiguous data elements may ultimately never be normalized, the system will still function properly, because when a user enters a query for which no matching data element exists in data element dictionary 200, content integration manager 106 will automatically search ambiguity data element dictionary 202 for a match.

The third primary dictionary component is the master keyword dictionary 204. Master keyword dictionary 204 contains keywords. The keywords stored in master keyword dictionary 204 comprise a list of words, that includes all of the data elements encountered in the databases as well as a group of industry words (which may be entered manually during the preparation of the system) which might be employed by a user when conducting a search or otherwise retrieving data. Therefore, keywords include every data element found in data element dictionary 200 and ambiguous data element dictionary 202, and also includes other words which are synonymous or similar to the data elements.

FIG. 5 illustrates an example of the arrangement of data in master keyword dictionary 204, in accordance with one embodiment of the present invention. According to this embodiment, master keyword dictionary 204 is arranged in a plurality of columns and rows. In a first column, all of the master keyword dictionary entry names are listed. Each master keyword dictionary entry name has a corresponding row of elements comprised of synonyms and weights.

In each row, field 801 contains the master keyword dictionary entry names, preferably arranged in alphabetical order. Field 802 contains a first synonym of field 801. However, the data relating to the keyword in field 802 may not be perfectly synonymous with the data relating to the master keyword dictionary entry name in field 801, but may instead be merely similar thereto. Therefore, in order to indicate that the data relating to the two keywords are similar but not perfectly synonymous, the synonym in field 802 has a weight indicated in field 803. Other synonyms and their weights relative to the master keyword dictionary entry name in field 801 are contained in additional columns as shown.

The weights corresponding to each word in the master keyword dictionary entry name's synonym set are, according to one embodiment, entered manually during the integration process. In the example shown, the weight comprises an integer between 0 and 5, wherein a weight of 0 means that the keywords are not synonymous at all, and a weight of 5 means that the keywords are perfectly synonymous. According to another embodiment, the weights comprise a percentage between 0% and 100%, although the present invention contemplates any means of performing this function.

The weights employed by master keyword dictionary component 204 assist content integration manager 106 to match data elements in one database with data element in other databases. FIG. 12 is a flowchart that illustrates the steps performed by a correlation algorithm of the system in order to determine the semantic equivalence of new data elements to those already in the system, according to one embodiment of the invention. This correlation algorithm may be employed with other flowcharts as shown in FIG. 13 through FIG. 17, which are explained in detail below.

In FIG. 12, at step 150, a vendor data element and its description is received for processing by the algorithm. At step 152, the system parses the description by removing extraneous words, leaving a set of keywords. At step 154, the system alphabetizes the remaining keywords and arranges them into a keyword array.

At step 156, the system selects the first word in the keyword array, and at step 158, compares the word to the entry names in master keyword dictionary 204. At step 160, the system determines whether any of the entry names in master keyword dictionary 204 match the keyword. If the system determines that an entry name in master keyword dictionary 204 does not match the keyword, then the method proceeds to step 162. At step 162, the system selects the next word in the keyword array and returns to step 158 so as to compare it with master keyword dictionary 204.

If, at step 160, the system determines that an entry name in master keyword dictionary 204 does match the keyword, then the method proceeds to step 164. At step 164, the system compares the remaining words in the keyword array to the synonym set of the matching master keyword dictionary entry name.

At step 166, the system determines whether the remaining words in the keyword array match the synonym set of the matching master keyword dictionary entry name. If the system determines that the remaining words in the keyword array match the synonym set of the matching master keyword dictionary entry name, then the system determines that the vendor data element and the master keyword dictionary entry are semantic equivalents at step 168, and exits at step 170. If the system determines that the remaining words in the keyword array do not match the synonym set of the matching master keyword dictionary entry name, then the system proceeds to step 172.

At step 172, the system performs various calculations which will be employed in order to determine a level of correlation between the vendor data element and the master keyword dictionary entry. For instance, the system determines the number of synonyms in the synonym set, and the total number of these synonyms which have a matching word in the keyword array. In addition, the system determines the total weight of all of the synonyms in the synonym set, and the total weight of the synonyms that have a matching word in the keyword array.

At step 174, because the system has found an entry in the master keyword dictionary that is at least partially equivalent to the vendor data element, the system stores the data calculated in step 172 in a “candidate” memory location. At step 176, the system selects the next word in the keyword array, and returns to step 158 to compare it to the master keyword dictionary as previously described. When the last word in the keyword array has been processed, the system proceeds to step 178.

At step 178, the system determines the best semantic candidate. According to one embodiment, the best semantic equivalent is the master keyword dictionary entry name that has the highest percentage of synonyms in its synonym set that has a matching word in the keyword array. For instance, if a first master keyword dictionary entry name has 10 synonyms in its synonym set and eight of these synonyms match eight words in the vendor data element's keyword array (80% match), it is the best semantic candidate compared to a second master keyword dictionary entry name that has 10 synonyms in its synonym set and five of these synonyms match five words in the vendor data element's keyword array (50% match).

At step 180, the system determines whether the best semantic candidate is actually equivalent to the vendor data element. According to one embodiment, the algorithm determines this by calculating whether the total weight of the matched words exceeds n% of the total weight of all of the synonyms in the synonym set. Preferably, n is a number between approximately 50 and 70. For example, expanding upon the example of the preceding paragraph, a total weight of all of the ten synonyms in the master keyword dictionary entry may be 35. If n=50%, then the semantic candidate is equivalent if the sum of the weights of the eight matching keywords is greater than 18.

If the best semantic candidate is equivalent to the vendor data element, then the method proceeds to step 182, where the dictionary system is updated to reflect that the vendor data element is semantically equivalent to an existing entry in the dictionary system. At step 184, the system exits the correlation algorithm. If the best semantic candidate is not equivalent to the vendor data element, then the method proceeds to step 186, where the system determines that the vendor data element is a new data element which is not semantically equivalent to any entry existing in the dictionary system. At step 188, the system exits the correlation algorithm. As mentioned above, further processing is performed in accordance with the flowcharts in FIG. 13 through FIG. 17.

Another dictionary component is the data element description database 208, which comprises the corresponding descriptions for each of the data elements in the system. Similar to master keyword dictionary 204, this component helps provide a logical understanding of the various data elements. FIG. 6 is a diagram that illustrates the arrangement of data in data element description database 208, according to one embodiment of the invention. In this embodiment, data element description database 208 comprises a plurality of rows, wherein each row corresponds to the name of a database. In each row, there are a plurality of fields. The first field of the row, designated as field 660, comprises the database name. Field 665 comprises identifiers of all of the data elements and all of the ambiguous data elements which can be found in the database in field 660. Field 670 contains descriptions of each of the data elements and ambiguous data elements in field 665. The description stored in field 670 is typically a description of the data element that is provided by the vendor and is accessed at the time of integration. In addition, if the description provided by the vendor is inadequate, the description can be supplemented manually during the integration process.

Another component of content integration manager server 104 is data element hierarchy component 210 (a second data element hierarchy component 212 is also shown, and will be explained below). During the aforementioned stage one, when a database is integrated into model server 104, the dictionary system must maintain all of the underlying structure from that database system. Data element hierarchy 210 contributes to this task by storing all hierarchical information from the corresponding database. Generally, a hierarchy is a graded or tiered system of relationships. Specifically, in the context of the present invention, a hierarchical relationship exists between various data elements when a first data element at the top of the hierarchy represents an aggregation of other data elements below it in the hierarchy.

For instance, FIG. 7(a) illustrates the arrangement of data elements in a hierarchical relationship in data element hierarchy 210, according to one embodiment of the present invention. At the highest, or first, hierarchical level is the data element “Sales”. On the next highest, or second, hierarchical level are the data elements “European Sales”, “Asian Sales” and “North American Sales”. Each of the data elements in the second hierarchical level have a relationship with the data element directly above it in the first hierarchical level, namely each of the data elements in the second hierarchical level is a subset of the data element directly above it in the first hierarchical level.

FIG. 7(a) also shows a third hierarchical level. In this level, the data elements in the second hierarchical level are further broken down into subsets of their own, such that each of the data elements in the third hierarchical level have a relationship with the data element directly above it in the second hierarchical level. For instance, for the data element “European Sales” in the second hierarchical level there are four subsets in the third hierarchical level, namely the data elements “Sales England”, “Sales France”, “Sales Spain” and “Sales Germany”. Likewise, for the data element “Asian Sales” in the second hierarchical level there are three subsets in the third hierarchical level, namely the data elements “Sales Japan”, “Sales China” and “Sales Singapore”, while for the data element “North American Sales” in the second hierarchical level there are also three subsets in the third hierarchical level, namely the data elements “Sales Canadian”, “Sales Mexico” and “Sales United States”.

By storing the hierachical structure of the data stored in the various databases, content integration manager server 104, in accordance with one embodiment, is able to inform the user that a requested data element is part of a hierarchy and will be able to present the entire hierarchy to the user. In this way, for instance, the user who requests information on a data element called “Sales” will be informed that further sub-categories (i.e.- lower hierarchical levels) exists that may be of greater usefulness to the user. Additionally, by informing the user that there exists further sub-categories, a user is less likely to inadvertently misunderstand the data which is made available to him or her.

Furthermore, by maintaining the hierarchical structure of the data base, content integration manager server 104 assures that hierarchical levels that have different names are not missed when a user enters a query. For instance, referring to a hierarchical structure as shown in FIG. 7(a), a first hierarchical level may be called “Sales”, and a data element in the second hierarchical level may be called “European Revenue”. By maintaining a record of the hierarchical structure in data element hierarchy component 210, content integration manager 106 helps prevent a query by the user for “Sales” from inadvertently not including data stored in memory locations corresponding to the data element “European Revenue”, merely because different data element names are employed to identify each.

FIG. 7(b) illustrates the arrangement of data in data element hierarchy 212, according to one embodiment of the invention. Data element hierarchy 212 employs an alternative method to store data in a hierarchical structure. In this case, data elements in the first hierarchical level have a prefix of “1”, such as “1DE1”. All data elements on a next lower hierarchical level than this data element have a prefix of “2”. They are shown to be related to the data element on the first hierarchical level by being enclosed in paranthetical brackets “[” and “]” immediately after the first level data element, such as “1DE1 [2DE1, 2DE2 . . . 2DE6]”.

All data elements on a still next lower hierarchical level than the second hierarchical level data elements have a prefix of “3”. They are shown to be related to the data element on the second hierarchical level by being enclosed in parenthetical brackets “{” and “}” immediately after the second level data element, such as “. . . 2DE3 {3DE1, 3DE2}. . . ”. It is noted, however, that these notations are merely convenient for demonstrating the arrangement of data in this format, and that other notations may be employed for the same purpose.

Another component of content integration manager 106 is data element grouping component 214. Data element group component 214 allows a user to define logical groupings of data elements. The user defines a data element group by creating a name for the grouping, defining it as a “group data element”, and naming the data elements that constitute the grouping.

FIG. 8 illustrates the arrangement of data in data element group 214, according to one embodiment of the invention. A first field, designated as field 680, contains the name of the data element group, as defined by the user. Fields 685-695 contains the name of each data element that is a member of the group. As will be further discussed below, grouping data elements into a single group enables a user to access all of the data elements in the group when a query is made regarding a single data element of the group.

Another component of content integration manager 106 is database relater 218. Database relater 218 enables the database usage to be tracked (e.g.-for billing purposes, for instance) when there are numerous databases that have been supplied by a single database aggregator. For instance, an aggregator may supply information from various different databases to a single user. In data element dictionary 200, the information which identifies the source of the data being retrieved would typically be the name of the aggregator. Database relater component 218 enables the useage of various databases supplied by the aggregator to be monitored.

FIG. 9 is a diagram that illustrates the arrangement of data in database relater 218, according to one embodiment of the invention. Database relater 218 has two types of entries. Field 700 defines a first entry type and contains the name of an aggregator. Fields 705 and 710 contain database names that correspond to the aggregator name in field 700. In addition, field 715 contains a database name, and has a corresponding aggregator name in field 720. In this arrangement, database relater 218 can receive either an aggregator's name or a database name and respond accordingly. Specifically, if the system looks up an aggregator's name, the user will be informed of the databases that are aggregated thereby, while if the system looks up a database name, the user will be informed that the database is aggregated under an aggregator.

Still another component of content integration manager 106 is data mapper 206. Generally, data mapper 206 contains a map for each data element that it stores, and contains all the information required by the system to locate a data element in content integration manager 106's set of dictionary components as well as the data element locations in the vendor's databases.

FIG. 10 is a diagram that illustrates the arrangement of data in data mapper 206, according to one embodiment of the invention. Data mapper 206 has an array for each database in the system. For instance, field 725 of data mapper 206 contains the name of each database. Field 726 stores a restricted database indicator that indicates that the entire database identified in field 725 is restricted to some users, as is discussed in further detail in connection with the flowchart in FIG. 17. Field 727 stores a restricted row indicator that indicates that a row in the database identified in field 725 is restricted to some users, while field 728 stores a partial restricted row indicator that indicates that only a part of a row of the database identified in field 725 is restricted to some users, as is also discussed below. Field 729 contains data element names as employed for row selection and indexing. Field 730 contains additional information about the database identified in field 725.

Each array of data mapper 206 also comprises, in field 735, the data elements or ambiguous data elements that can be found in the database identified in field 725. Field 740 has a data element/ambiguous data element indicator, which indicates whether field 740 contains a data element which can be found in data element dictionary 200 or an ambiguous data element which can be found in ambiguity data element dictionary 202. Field 741 is a data element hierarchy or data element group indicator that indicates if the data element or ambiguous data element in field 735 belongs to a hierarchical structure as originally stored in the vendor's database system or belongs to group created by the user.

Field 742 contains a restricted data element indicator. The restricted data element indicator indicates whether the data element or ambiguous data element stored in field 735 is restricted from access by some users, as is discussed in further detail in connection with the flowchart in FIG. 17. Field 745 is a field locator, which indicates the location of the data element in the vendor's database, and field 746 stores the type of data stored therein.

Additionally, data mapper 206 has, for each data element, field 750, that contains data element special instructions. For instance, according to one embodiment of the invention, the data element special instructions field performs one of two functions. The first function is referred to as “codes data element”. The “codes data element” employs a numerical assignment inorder to identify the use of a code by a database. Examples of “codes” are: a currency symbol, country code, state abbreviations, dividend period codes, corporate action codes, etc. In one embodiment, the data element special instructions field of data mapper 206 contains an indicator that a code has been employed. A separate code database may then be employed to look up what the code specifically means. The use of codes is common in existing databases, and the use of a data element special instruction field for this purpose insures that these codes are recognized by the integrated dictionary system.

A second function which may be performed by the data element special instructions field of data mapper 206 is an anomaly indicator. In this instance, data mapper 206 employs a data element special instructions anomaly indicator in field 750 of FIG. 10. This indicator indicates to the system that there are two data elements in the dictionary system that have the same name, but are to at least some degree different in meaning (i.e. an anomaly). The differences can be found in data element description database 208, where the descriptions of both terms are stored, and in master keyword dictionary 204, which contains both data elements and their corresponding synonyms.

With continued reference to FIG. 10, field 755 of data mapper 206 contains an active/deactive indicator. The active/deactive indicator is employed to inform the system of the existence of a data element that is no longer current in the database or that will be current in the future. Field 760 contains an active/deactive date that corresponds to the date which the active/deactive indicator of field 755 assumed its current position.

Still another component of content integration manager 106 is restricted database component 219. Generally, restricted database component 219 contains the information needed to identify the records that are restricted from being accessed by some users. FIG. 11 is a diagram that illustrates the arrangement of data in restricted database component 219, according to one embodiment of the invention. Field 765 stores the name of a database and field 770 stores an index data element which is desired to be restricted. A symbol such as “,” or “—” is stored in value array format indicator field 775 of restricted database 219, while a sorted value array is stored in ordered value array field 780. The purpose of these fields will be discussed in greater detail below in connection with FIG. 17.

FIG. 13 is a flow chart that illustrates, in accordance with one embodiment of the invention, the steps performed by content integration manager 106 in order to integrate multiple databases onto one platform so that users may conduct expansive searches or queries regardless of the database management system from each respective database. Ideally, other databases have already been integrated onto content integration manager 106, so that an extensive set of data elements and descriptions are available for ease of processing new databases. In accordance with one embodiment of the present invention, databases are integrated one at a time. It is also noted that, although the system eventually will semi-automatically perform all of the steps of integration, some manual steps are initially performed in order to prepare a database for integration. For instance, according to one embodiment of the invention, it is initially necessary for the descriptions of data elements to be manually expanded, edited and entered by a user of the system, and to edit weights with regards to the synonym sets of data elements.

With reference to the flowchart of FIG. 13, at step 190, the system starts. At step 191, the system determines whether the data element hierarchy or the data element group indicators are set in field 741 of data mapper 206 as shown in FIG. 10. If the system determines at step 191 that the data element hierarchy or the data element group indicators are set in field 741, then the method proceeds to step 192, which directs the system to perform the steps illustrated in the flowchart of FIG. 15. If the system determines at step 191 that the data element hierarchy or the data element group indicators are not set in field 741, then the method proceeds to step 193.

At step 193, the system determines whether the data to be entered is desired to be restricted. If the system determines at step 193 that the data is desired to be restricted, then the method proceeds to step 194, which directs the system to perform the steps illustrated in the flowchart of FIG. 17. If the system determines at step 193 that the data is not desired to be restricted, then the method proceeds to step 195.

At step 195, the system determines whether the user desires that the system be in processing mode. If the system determines at step 195 that the user does not desire the system to be in processing mode, then the method proceeds to step 196, which directs the system to operate in maintenance mode. In maintenance mode, the system displays to the user various options which may be performed, such as deleting databases or data elements from any the data dictionaries, the data element hierarchy component 210 or data element group component 214, or any other operation which adjusts existing data in the system.

If the system determines at step 195 that the data is desired to be used in processing mode, then the method proceeds to step 200 in order to begin the process of integrating new data into the system. At step 200, content integration manager 106 receives a vendor data element name via interface computer system 102. As previously discussed, a vendor data element is a data element name which is employed in a database which is being integrated.

At step 205, the system compares the vendor data element to all of the data elements stored in data element dictionary 200. At step 210, the system inquires whether the vendor data element matches any of the data elements stored in data element dictionary 200. If, at step 210, the system determines that the vendor data element does not match any of the data elements stored in data element dictionary 200, the system proceeds to step 215.

At step 215, the system compares the vendor data element to all of the data elements stored in ambiguous data element dictionary 202. At step 220, the system inquires whether the vendor data element matches any of the data elements stored in ambiguous data element dictionary 202. If, at step 220, the system determines that the vendor data element does not match any of the data elements stored in ambiguous data element dictionary 202, the system performs the steps illustrated by the flow chart in FIG. 14. If, at step 220, the system determines that the vendor data element does match a data element stored in ambiguity data element dictionary 202, the system performs the steps illustrated by the flow chart in FIG. 16.

If, at step 210, the system determines that the vendor data element does match one of the data elements stored in data element dictionary 200, the system proceeds to step 225. At step 225, the system matches the vendor data element to a data element which is stored in master keyword dictionary 204. As previously discussed, master keyword dictionary 204 contains a list of keywords which include both data elements as well as a set of manually-supplied, synonymous industry words.

After step 225, the system proceeds to step 230, at which a vendor data element description is employed to generate a keyword array. The vendor data element description is a description of the data stored in the data element of the database being analyzed. As previously mentioned, this description may exist in the database or it may be manually generated during the integration process. The keyword array, which is explained in greater detail below, is an array which comprises the primary words of the description of a data element, without extraneous words such as “the”, “a” or “and” (to name just a few).

At step 235, the system next compares the keyword array generated in step 230 to the corresponding entry of master keyword dictionary 204. The corresponding entry of master keyword dictionary 204, as previously discussed, comprises a set of synonyms of the keyword, along with their respective weights.

At step 240, the system determines whether the keyword array, when compared to the corresponding entry of master keyword dictionary 204, has a high or a low correlation. If the system determines that the keyword array when compared to the corresponding entry of master keyword dictionary 204 has a low correlation (because the words in the description have a relatively low weight according to the synonym set), then the system proceeds to step 245. If the system determines that the keyword array when compared to the corresponding entry of master keyword dictionary 204 has a high correlation (because the words in the description have a relatively high weight according to the synonym set), the system proceeds to step 270 (discussed further below).

At step 245, the system adds data element special instructions anomaly indicator information to data mapper 206. The data element special instruction anomaly indicator is employed by the system in order to minimize the likelihood of confusion when the vendor data element entered by the user matches a keyword in master keyword dictionary 204 but there is a low correlation between the vendor data element and the keyword. This may occur when the vendor data element and the keyword are the same or very similar, but in fact describe different things in reality. By adding the data element special instruction anomaly indicator information to data mapper 206 for the data element in question, content integration manager 106 knows that there will be two entries in master keyword dictionary 204 which have the same name but which describe different things.

The system next proceeds to step 250. At step 250, the system adds an ambiguity indicator to the data element that matched the Vendor data element or that matched the master keyword dictionary entry. Once again, the ambiguity indicator is required because the system has determined that the vendor data element has the same name as a data element but is semantically different, or that the vendor data element has the same name as a master keyword dictionary entry. At step 255, the system adds the data element name from data element dictionary 200 to the mapped data element field in ambiguity data element dictionary 202.

At step 260, an entry is added to ambiguity data element dictionary 202. It should be noted that, according to one embodiment of the invention, there are two ways that an ambiguous data element is created. In a first instance, a vendor data element matches a data element, but has a low correlation when the synonyms are compared in master keyword dictionary 204.

In a second instance, the vendor data element does not match a data element in data element dictionary 200 or an ambiguous data element in ambiguity data element dictionary 202, but achieves a high correlation against a synonym set in master keyword dictionary 204. The matched synonym set's name (the entry name in master keyword dictionary 204) is then matched to the data element in data element dictionary 200. An anomaly indicator is set in the matched data element entry of data element dictionary 200 and the vendor data element is used to create a new ambiguous data element in ambiguity data element dictionary 202 which is linked to the matched data element of data element dictionary 200.

Returning to the performance of step 260, the system adds a new entry to ambiguity data element dictionary 202 by adding the vendor data element to ambiguity data element dictionary 202. In addition, the system adds the database name to field 645 of ambiguity data element dictionary 202. At step 265, the system also adds the vendor data element to the list of keywords in master keyword dictionary 204, thus creating a new entry therein. In addition, the array created from the description of the vendor data element in step 230 is added to the new master keyword dictionary entry. Upon completion, the system then performs an exit processing procedure as explained in connection with step 280.

Returning to step 240, if the system determines that the keyword array of the vendor data element, when compared to the corresponding entry of master keyword dictionary component 204 has a high correlation, the system proceeds to step 270. At step 270, the system adds more synonyms to the corresponding master keyword dictionary entry. Specifically, the system extracts from the array (that was created from the description) all words that are not duplicates of the existing master keyword dictionary entry's synonym set. All of these additional words are then weighed in their similarity to the keyword of master keyword dictionary 204 by employing a weight algorithm, or by manually entering weights for each. The words and their corresponding weights are then added to master keyword dictionary 204 entry's synonym set.

At step 275, the system adds the database name in which the vendor data element is found to data element dictionary 200 entry for the matching data element name. The performance of steps 270 and 275, by adding new synonyms to master keyword dictionary 204 entry, increases the knowledge of content integration manager 106 relative to a particular data element, thus enabling content integration manager 106 to automatically determine matching entries in the future. In other words, when a new vendor data element and its description is subsequently integrated, the system will be able to compare the description to a greater number of synonyms in master keyword dictionary 204, thus increasing the likelihood of “understanding” the nature of the data stored in the vendor data element, and of correctly matching it with existing data elements in the system.

The system next proceeds to step 280, at which is performed exit processing, as previously mentioned. At step 280, a data mapper entry is created for the current vendor data element along with the database which it can be found in. Additionally, the codes of the database are updated, if applicable. Also, the data element description database 208 and database relater 218 are updated with the description information of the vendor data element.

FIG. 14 is a flow chart that illustrates additional steps as performed by the system of the present invention, in accordance with one embodiment. Specifically, the steps of the flow chart in FIG. 14 are performed by the system when, at step 220 of FIG. 13, it is determined that the vendor data element does not match any of the data elements stored in ambiguous data element dictionary 202. At step 300, the system compares the vendor data element to master keyword dictionary 204 entry names for a match. This step is performed because, although the vendor data element did not match a data element in data element dictionary 200 or an ambiguous data element in ambiguity data element dictionary 202, there may be industry words which were manually added to master keyword dictionary 204 that provide a match. At step 305, the system inquires whether the vendor data element matches any of the entry names stored in master keyword dictionary 204. If, at step 305, the system determines that the vendor data element does match an entry name stored in master keyword dictionary 204, the system proceeds to step 310. At step 310, the system deletes the existing master keyword dictionary entry name and its synonym set, and proceeds to step 325. If, on the other hand, the system determines at step 305 that the vendor data element does not match any of the entry names stored in master keyword dictionary 204, the system proceeds to step 325.

As previously noted, when the system determines that the vendor data element does match an entry name stored in master keyword dictionary 204, it is important to note that master keyword dictionary 204 entry name must have been created manually during the process of integrating master keyword dictionary 204. This follows because the vendor data element did not match a data element in data element dictionary 200 or ambiguity data element dictionary 202. The only master keyword dictionary entries that are not also entries in data element dictionary 200 and ambiguous data element dictionary are those which are manually created, and it is merely coincidental that the vendor data element 's description when employed to generate a synonym array matched an existing master keyword dictionary synonym set.

Returning to step 305, if the system determines that the vendor data element does not match any of the entry names stored in master keyword dictionary 204, the system proceeds to step 325. At step 325, the system uses the vendor data element description to form a keyword array. In accordance with the preferred embodiment, the array is alphabetized.

The system then proceeds to step 330. At step 330, the system compares the array formed in step 325 to each of the existing master keyword dictionary synonym sets. This step of the method is performed so as to determine if the vendor data element is a different word from, but has a semantic equivalence to, any data element in data element dictionary 200 or ambiguity data element dictionary 202. Since the array and the synonym sets are both alphabetized, the comparison can be performed efficiently.

At step 335, the system inquires whether the array matches any of the synonym sets in master keyword dictionary 204. If, at step 335, the system determines that the array does not match any of the synonym sets in master keyword dictionary 204, or that there is a low correlation between the array and the synonym sets, the system proceeds to step 340. If the system determines at step 335 that the array does match a synonym set in master keyword dictionary 204, or that there is a high correlation between the array and the synonym set, the system proceeds to step 345.

At step 340, when the system has determined that the array does not match any of the synonym sets in master keyword dictionary 204 or that there is a low correlation between the array and the synonym sets, the system adds the new data element to data element dictionary 200. In addition, at step 340, the system creates a new master keyword dictionary entry name and synonym set, using the vendor data element inputted by the user and the array that was formed at step 325. The system then proceeds to step 385, where it performs exit processing, as previously described.

On the other hand, when the system determines at step 335 that the array does match a synonym set in master keyword dictionary 204 or that there is a high correlation between the array and the synonym sets, the system proceeds to step 345. Step 345, and the steps that follow it, are performed because at this point the vendor data element has not matched a data element in data element dictionary 200, ambiguous data element dictionary or master keyword dictionary 204. However, the vendor data element's array has matched a master keyword dictionary entry's synonym set, and it may be that the syntax of the vendor data element is different from others in the system but has the same semantics. Thus, at step 345, the system compares the matched master keyword dictionary entry name to data element dictionary 200.

At step 350, the system inquires whether the matched master keyword dictionary entry name matches a data element in data element dictionary 200. If the system determines at step 350 that the matched master keyword dictionary entry name does match a data element in data element dictionary 200, then the system proceeds to step 355. If, on the other hand, the system determines at step 350 that the matched master keyword dictionary entry name does not match a data element in data element dictionary 200, then the system proceeds to step 360.

At step 355, the system sets the link indicator (shown as field 612 in FIG. 3) in the data element entry name that matched and returns to step 255 of the flowchart illustrated in FIG. 13. Generally, the system creates a new ambiguous data element in ambiguity data element dictionary 202 out of the vendor data element, and links it to the data element in data element dictionary 200 that was found by comparing the matched master keyword dictionary entry name.

At step 360, when the system has determined at step 350 that the matched master keyword dictionary entry name does not match a data element in data element dictionary 200, the system inquires whether the master keyword dictionary entry name exists in ambiguity data element dictionary 202. If not, then the system proceeds to step 362. At step 362, the system eliminates or deletes the master keyword dictionary entry that yielded the correlation at step 335. At step 364, the system creates a new master keyword dictionary entry which corresponds to the vendor data element and the keywords derived from the description. In addition, at step 366, the system creates a new data element in data element dictionary 200 by using the vendor data element and the database name, and, at step 368, performs exit processing, as previously described.

If the system determines at step 360 that master keyword dictionary 204 entry name does exist in ambiguity data element dictionary 202, the system proceeds to step 370. At step 370, a new data element is created in data element dictionary 200. In order to accomplish this, the system adds the vendor data element to data element dictionary 200 and adds the database name to the new data element entry. In addition, at step 370, the system creates a new master keyword dictionary entry using the vendor data element and the keywrods derived from the description.

At step 380, the system sets the link indicator (shown as field 612 in FIG. 3) in the data element entry of data element dictionary 200, which was just created in step 370. In addition, the system adds the ambiguous data element to the “linked data element” field (shown as field 615 in FIG. 3) in the data element entry. As previously mentioned, the “link indicator” and the “linked data element” is empoyed to link the data element to an ambiguous data element that has a different name but has the same or similar semantics. Also, the system adds the vendor data element to the mapped data element field in ambiguity data element dictionary 202. Lastly, the system performs the exit processing at step 385.

FIG. 15 is a flow chart that illustrates additional steps performed by the system of the present invention, according to one embodiment. Specifically, the system of the present invention performs the steps illustrated in the flow chart of FIG. 15 when the system determines, at step 295 of the flow chart illustrated in FIG. 13, that the data element hierarchy, the data element group or the index data element indicators are on. In FIG. 15, the system inquires at step 400 whether the data element hierarchy or the data element group is the last entry to be processed. If not, then the system proceeds to step 405 and provides the user with a return error.

Otherwise, the system proceeds to step 410. At step 410, the system determines whether the data elements named in the data element hierarchy, data element group array or index data element are valid data elements. The data elements are valid if they are in either data element dictionary 200 or ambiguous data element dictionary. If the data elements are not valid, then the system proceeds to step 405 and provides the user with a return error. If the data elements are valid, then the system proceeds to step 420. At step 420, the system builds a data element hierarchy or data element group array and updates content integration manager 106 dictionaries.

FIG. 16 is a flow chart that illustrates additional steps performed by the system of the present invention, according to one embodiment. Specifically, the system of the present invention performs the steps illustrated in the flow chart of FIG. 16 when the system determines, at step 220 of the flow chart illustrated in FIG. 13, that the vendor data element does match a data element stored in ambiguity data element dictionary 202. At step 500, the system finds an entry corresponding to the ambiguous data element in master keyword dictionary 204. An entry corresponding to the ambiguous data element is known to be in master keyword dictionary 204 because all of the data elements from data element dictionary 200 and ambiguity data element dictionary 202 are stored in master keyword dictionary 204, and, as determined in step 220, the vendor data element has a match in ambiguity data element dictionary 202.

At step 505, the system uses the vendor data element description to generate a keyword array. As previously discussed, the keyword array is the description corresponding to the vendor data element without the extraneous words. At step 510, the system compares the keyword array to the synonym set of the corresponding master keyword dictionary entry.

At step 515, the system inquires whether there is a correlation between the keyword array and the synonym set of the corresponding master keyword dictionary entry. If the system determines that there is a low correlation between the keyword array and the synonym set of the corresponding master keyword dictionary entry, the system proceeds to step 520. On the other hand, if the system determines that there is a high correlation between the keyword array and the synonym set of the corresponding master keyword dictionary entry, the system proceeds to step 530.

At step 520, the system creates a new data element in data element dictionary 200. This data element is mapped to a corresponding entry in ambiguity data element dictionary 202 through its “mapped DE” field. Also, at step 520, the system creates a corresponding new master keyword dictionary entry. The method then proceeds to step 525.

At step 525, the system sets the ambiguity indicator in the data element entry of data element dictionary 200. The system also sets the data element special instruction anomaly indicator in data mapper 206 of the new data element entry. The data element special instruction anomaly indicator is being set in this step because a new master keyword dictionary entry name is being created with the same name as an existing entry, albeit with a different synonym set. The system then proceeds to perform exit processing, as previously described.

On the other hand, if the system determines that there is a high correlation between the keyword array and the synonym set of the corresponding master keyword dictionary entry, step 530 is performed. At step 530, the ambiguous data element and its corresponding information is removed from ambiguity data element dictionary 202. At step 535, a new data element dictionary entry is created, employing the name and the database from ambiguity data element dictionary 202.

At step 540, the system combines the array generated from the vendor data element's description array and the existing master keyword dictionary synonym set. In this case, an ambiguity indicator is not required in data element dictionary 200 entry. Finally, after step 540 is completed, the system performs exit processing.

As previously mentioned, the second stage of the present invention, according to one embodiment, is the retrieval of data by a user. The present invention allows a user to make a query for data which is stored in a plurality of databases, and to retrieve that data regardless whether the databases have different database management systems.

FIG. 17 is a flow chart that illustrates the steps performed by the system, according to one embodiment of the invention, in order to restrict data stored in the system. The system performs these steps when, at step 180 of the flowchart in FIG. 13, the system determines that the user desires data to be restricted. Typically, data is restricted when it is desired that not all persons who use the system be able to access speciic data, such as for purposes of security or confidentiality.

In FIG. 17, at step 900, the system checks that the database desired to be restricted is a valid database name in the system. If not, then the system will return an error to the user, and instruct the user to enter another database name. If the database name entered by the user is a valid database name, then the method proceeds to step 902. At step 902, the system accesses the data mapper according to the database name entered by the user.

At step 904, it is determined what kind of restriction is desired to be imposed on the data. According to one embodiment, there are four classes of restriction which may be imposed on data. According to a first class of restriction, it is desired to restrict access to an entire database. If this is the case, the system proceeds to step 906. At step 906, the system sets the “restricted database indicator” in field 726 of data mapper 206 as shown in FIG. 10, so that when a subsequent user seeks to access the data corresponding to the database, the user will be required to demonstrate eligibility to access the data therein. For instance, it may be desired that only the human resources personnel in a corporation have access to a database in which is stored the salaries of all persons working for the company. If a person who was not a human resources personnel employed the system to access data in this database, the system would detect that the “restricted database indicator” field 727 was set, and require the user to satisfy a security check, such as by entering a pin number or password, etc. prior to disseminating the data. At step 908, the system exits.

According to a second class of restriction, a user desires to restrict access to all instances of a particular data element. If this is the case, the system proceeds to step 910. At step 910, the system sets the “restricted data element indicator” in field 727 of data mapper 206 as shown in FIG. 10, so that when a subsequent user seeks to access the data corresponding to the data element, the user will be required to demonstrate eligibility to access the data stored therein. At step 912, the system exits.

According to a third class of restriction, it is desired to restrict all of the data in a row or in a range of rows. At 914, the system determines that this is the type of restriction desired. At step 916, the system determines whether the row identifier is an index data element. In order to do this, the system checks field 729 of data mapper 206 as shown in FIG. 10. If, at step 916, the system determines that the row identifier is not an index data element, the method proceeds to step 918 to return an error to the user. If the system determines that the row identifier is an index data element, the method proceeds to step 920. At step 920, the system sets the restricted row indicator field 727 of data mapper 206 as shown in FIG. 10. The system then proceeds to step 936, as explained below.

According to a fourth class of restriction, it is desired to restrict a particular data element or data elements in a row or in a range of rows. At 922, the system determines that this is the type of restriction desired. At step 924, the system determines whether the row identifier is an index data element. As explained inconnection with step 916, in order to do this, the system checks field 729 of data mapper 206 as shown in FIG. 10. If, at step 924, the system determines that the row identifier is not an index data element, the method proceeds to step 926 to return an error to the user. If the system determines that the row identifier is an index data element, the method proceeds to step 928 At step 928, the system determines whether all of the data elements to be restricted are valid data elements. If not, then the system returns an error to the user at step 930. If all of the data elements to be restricted are valid data elements, then the system proceeds to step 932. At step 932, the system sets the partial restricted row indicator field 728 of data mapper 206 as shown in FIG. 10. The system then proceeds to step 936.

At step 936, the system creates an entry in the restricted database using the database name inputted by the user and the index data element name. Specifically, the system stores the database name inputted by the user in database name field 765 of restricted database 219, and stores the index data element in index data element field 770 of restricted database 219.

At step 938, the system stores the appropriate symbol in value array format indicator field 775 of restricted database 219 corresponding to the entry created in step 936. According to a preferred embodiment, the symbols which are employed are “, ”, “—” and “X”, wherein each symbol helps the system to identify which rows are restricted. For instance, the symbol “,” means that the value array format has a string of values separated by commas, while the symbol “—” means that the value array contains a range of restricted rows and the symbol “X” means that the value array contains a field that identifies an “all rows” condition.

At step 940, the system sorts the input values that identify which rows are restricted. According to a preferred embodiment, the system sorts the input values by alphabetizing them in ascending order. At step 942, the system stores a sorted value array in ordered value array field 780 of restricted database 219. At step 944, the system stores the new entry in restricted database 219.

At step 946, the system determines whether there is another row in the input. If there is not another row, then the system proceeds to step 948 and exits. If there is another row, the system proceeds to step 950. At step 950, the method returns to step 916 if the data desired to be restricted is a row or a range of rows, while the method returns to step 924 if the data restricted is a data element or data element in a row or within a range of rows.

FIG. 18 is a flowchart that illustrates the steps performed by the system of the present invention to facilitate the retrieval of data from databases, in accordance with one embodiment. At step 960, a user enters a query for a data element (referred to hereinafter as a “query data element ” ) via interface 102. The query data element is typically a word or set of words which describes the type of data which the user desires to receive information on. For instance, a user may enter a query data element called “Revenue” when accessing financial databases in order to receive information about the revenue generated by various companies.

At step 962, the system translates the query data element into a request block. A request block is an internalized version of the client's request, having the appropriate syntax to be processed by the system. Additionally, the request block may be logged for subsequent processing, such as for billing, usage pattern studies, etc. Generally, the request block is a system-friendly form of the user's screen entries.

At step 964, the system employs the request block to construct a management control block. Generally, a management control block is employed to manage the flow of steps and the assembling of results. Each step of the retrieval process adds information to the management control block or uses information previously stored therein.

At step 966, the system examines the management control block in order to determine which data elements to search for in the dictionary components of the system. At step 968, the system inquires whether the data element determined in step 966 is located in data element dictionary 200. In order to do this, the system checks field 600 of data element dictionary 200 in order to find a match. If the system determines at step 968 that the data element is located in data element dictionary 200, the system proceeds to step 970. On the other hand, if the system determines at step 968 that the data element is not located in data element dictionary 200, the system proceeds to step 972.

At step 970, when the system determines at step 968 that the data element is located in data element dictionary 200, the system retrieves other corresponding information from the corresponding entry of data element dictionary 200. For instance, the system retrieves the database names in fields 605-620 of data element dictionary 200 corresponding to the data element that was matched in step 968. These database names identify the databases that the matched data element can be found in.

At step 972, when the system determines at step 968 that the data element is not located in data element dictionary 200, the system inquires whether the data element determined in step 966 is located in ambiguity data element dictionary 202. If the system determines at step 972 that the data element is located in ambiguity data element dictionary 202, the system proceeds to step 974. On the other hand, if the system determines at step 972 that the data element is not located in ambiguity data element dictionary 202, the system proceeds to step 990. At step 990, the system returns an error message to the user. This error message informs the user that the query data element which was entered does not exist, thereby requiring the user to enter a different query.

At step 974, when the system determines at step 972 that the data element is located in ambiguity data element dictionary 202, the system retrieves other corresponding information from the corresponding entry of ambiguity data element dictionary 202. For instance, the system retrieves the database name in field 645 of ambiguity data element dictionary 202 corresponding to the ambiguous data element that was matched in step 972. This database name identifies the databases that the matched ambiguous data element can be found in. Additionally, at step 974, the system retrieves the mapped data element name from field 650 of ambiguity data element dictionary 202, as well as the databases that correspond to the mapped data element in data element dictionary 200. Thus, at step 974, the system retrieves the ambiguous data element that matches the user's query data element, as well as the data element in data element dictionary 200 that, during the integration stage, was found to be ambiguously related to the ambiguous data element.

Upon the completion of either step 970 or 974, the system proceeds to step 976. At step 976, the system retrieves from data mapper 206 the array that corresponds to each database identified in steps 970 or 974. For instance, if a matching data element was found in data element dictionary 200 in step 968, each database identified in step 970 as having the corresponding data element located therein has its corresponding array in data mapper 206 retrieved at step 976. On the other hand, if a matching data element was found in ambiguity data element dictionary 202 in step 972, each database identified in step 974 as having the corresponding data element or the corresponding ambiguous data element located therein has its corresponding array in data mapper 206 retrieved at step 976.

At step 978, the system loads the field locator of each array into the master control block. In addition, if the matching data element was found in ambiguity data element dictionary 202 at step 972 instead of in data element dictionary 200 at step 968, the system also loads the special instructions from field 750 of data mapper 206. As previously mentioned, field 750 contains data element special instructions that perform a “codes data element” function or that are employed as an anomaly indicator to indicate that there are two data elements in the dictionary system that have the same name but different meanings.

At step 980, the master control block is passed to a database retrieval system. The database retrieval system is configured to access the necessary databases and retrieve the data which is associated with the query data element, as determined by the system in the previous steps. At step 982, the database retrieval system accesses these databases and retrieves the data. At step 984, the system assembles the data. Each step of assembling the results of the search adds information to the master control block, which functions as a storage container for the retrieved information. Finally, at step 986, the system performs end-state processing, which comprises configuring the data for display to the user and then displaying the data.

FIG. 19 is a block diagram of the application container and related components of this invention, according to one embodiment of the invention. Computer system 102 comprises CPU 300, which is coupled to application container 302. Application container 302 manages the initiation, operation, serialization and cessation of all of the applications running in the system. Typically, the application container manages an application such as JavaBeans, which is configured to perform a variety of functions on data. Applications container 302 is coupled to translation layer 304, which translates the application container syntax into interface definition language for use by model server 104.

FIG. 20 is a block diagram that illustrates an overall architecture of the system of the present invention, in accordance with one embodiment. As shown in FIG. 20, the system of the present invention may be employed for various data retrieval functions. For instance, the application container can be configured to retrieve data according to channels. Channels are employed to perform specific utility type functions for the client.

A first type of channel (also referred to as a model class) which the application container is advantageously configured to employ is a housing code. A housing code is employed to retrieve a particular type of data from a particular data source. In a preferred embodiment, the system is configured to either “push” or “pull” data in response to a request from a user. Data is “pulled” when the user makes a specific request for data and physically retrieves it from the database in which it is stored, while data is “pushed” when the database in which the requested data is stored physically delivers the data to the user.

Referring to FIG. 20, a housing code may be employed to retrieve data from any one of multiple external data feeds 118. In one instance, the user may request news data, such as that stored in news database 122. The data in news database 122 is stored in XML (extended markup language) format, and is received, via news server/agent 124, by XML processor 126 of model server 104. News extractor 128 extracts the news data for delivery to the user. In another instance, the user requests stock quotes, which is satisfied by data in quotes database 120. The data in quotes database 120 is stored in CORBA (common object request broker architecture) format, and is received by TCP/IP socket processor 130 of model server 104. Quote extractor 132 extracts the stock quote data for delivery to the user.

The model class of channel, as employed by the present invention, may also be programmed to parse information from web sites on the Internet or a corporate intranet at a specified interval. They may also be employed to store user preference information, such as a specific portfolio of stocks which the user is interested in tracking. In the “Observer-Observable” software design pattern which is typical in the prior art, model channels are “observable” objects because they specify a type of object which generates events which may be observed or procesed by an “observer”.

A second type of channel (also referred to as a view class) which the application container is advantageously configured to employ is an instruction code. An instruction code contains instructions defining which specific graphical components should be employed to present the data retrieved by the channel. For instance, if data was retrieved relating to stock quotes, the instruction code may instruct the system to present the stock quote data to the user in the form of a stock ticker. In another instance, if data was retrieved relating to news, the instruction code may instruct the system to present the news data to the user in the form of a scrolling headline display. In the “Observer-Observable” software design pattern which is typical in the prior art and which was referenced above, view channels are “observer” objects, thus receiving events when data is changed and automatically updating thier display. Still another type of channel binds the model and view components together.

FIG. 20 also shows file 134 which contains entitlement resources. Entitlement file 134 communicates with model server 104 via LDAP server 136. Every user of the system is defined to the system in an LDAP directory of LDAP server 136. Within the directory, the user is identified, along with the databases the user has access to and the components of the database the user can read (if applicable). In addition each access of the system and the system databases is authenticated and recorded for billing purposes.

Model server 104, according to one embodiment of the invention, also performs serialization procedures. Specifically, at start up time, serialization recreates the client's environment exactly the way it was at the time the client last brought the system down. In addition to the re-instatement of the system through serialization, the system scans a directory containing Channel binary files. In the preferred embodiment, all channels employed by application container 302 are implemented as JavaBeans and stored in Java Archive (JAR) files. The main code reads each JAR file in this special directory and discovers any channels that are contained within the JAR. Once the channels are discovered, they are automatically queried for basic information such as the title of the channel, and a small graphical icon representing the channel. This information is cached and used later to allow the user to add and remove active channels.

In another embodiment of the invention, the system employs a process referred to as “versioning”. New versions of JAR files may be stored on a remote server for the purpose of automatic software upgrades. At startup, model server 104 is queried to determine if a newer versions of any application exists. This process is accomplished by comparing the version stamp of the local JAR file with the version reported by the server. If a newer version exists, the user is prompted to upgrade, and if the decision is made to do so, the new JAR file (or files) is automatically downloaded from the server to a special directory for that purpose. In this manner, applications software is automatically upgraded with minimal user intervention. System administrators may optionally force upgrades without explicit user acceptance, thus providing powerful central administration of software distribution. Any errors that occur during the automatic upgrade process can be logged and analyzed. In addition to new versions of existing channels, totally new channels may be sent to client systems in the same manner.

In still another embodiment, the system of the present invention employs a cache. For instance, a client's request for data can yield a wide variety of responses from the server: type of data, format of data, size of data, meta data, etc. The data and/or the information describing the data is advantageously cached prior to presentation on the client's desktop. Some of the types of data that the system may employ are:

Numerical/alpha data (say a matrix) that can fit on a client screen;

Numerical/alpha data that can not fit on a single screen but can fit in a reasonable memory based cache;

Numerical/alpha data that can not fit on a single screen AND can not fit in a reasonable memory based cache, but which can fit on a client based disk cache;

Numerical/alpha data that can not conveniently fit on the client, wherein the data is stored on the server (MS-cache);

Numerical/alpha data that can not conveniently fit on the server; and

Meta data will be cached on the client and/or the MS depending on processing (retrieval) characteristics.

The present invention preferably employs two types of data caching structures, although the invention is not limited in scope in this respect. One type of data caching structure is the client disk cache. According to this structure, at system load time, an amount of disk space is allocated to application container 302 for caching purposes. Another type of data caching structure is the server disk cache, which employs a significantly large amount of disk space. Its size is a function of the estimated maximum number of simultaneous users (SU) multiplied by an amount of disk space allotted per user.

When the response to a request is too large to be cached, the system returns information that will allow the user to navigate the databases and access the information in “pages”. This navigation information is cached at the client. Along with the navigation information, the “first page” of data is returned to the client with the appropriate messages, i.e., an indication of “more information available” and access instructions.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

What is claimed is:

1. A method for creating a virtual data warehouse employing a plurality of databases, said method comprising the steps of:
storing in a dictionary system a plurality of data elements, each of said data elements corresponding to at least one data element in said plurality of databases;
identifying relationships between two or more of said data elements in said dictionary system;

2. The method of claim 1, further comprising the step of storing said plurality of data elements in a data element dictionary, said data element dictionary configured to identify each said database that said data elements are found in.

3. The method of claim 1, further comprising the step of storing a plurality of keywords in a master keyword dictionary, said plurality of keywords further comprising a list of every said data element, a group of industry words, and each said keyword having a synonym set.

4. The method of claim 3, wherein, in said step of storing said plurality of keywords in said master keyword dictionary, said synonym set of each said keyword comprises a plurality of words having a relationship with said keyword.

5. The method of claim 4, wherein, in said step of storing said plurality of keywords in said master keyword dictionary, said plurality of words having a relationship with said keyword comprises a plurality of said data elements.

6. The method of claim 5, further comprising the step of maintaining, in said master keyword dictionary, a weight for each relationship between a keyword and each word in said keyword's synonym set, said weight corresponding to a measure of similarity between said keyword and each word in said keyword's synonym set.

7. The method of claim 6, further comprising the step of storing, in an ambiguity data element dictionary, a plurality of ambiguous data elements, said ambiguous data elements comprising data elements from said databases that have the same name as another data element but a different meaning.

8. The method of claim 6, further comprising the step of employing an application container to retrieve said data via channels.

9. The method of claim 8, wherein said application container employs a model channel, said model channel configured to retrieve data from a particular data source, and a view channel, said view channel configured to instruct the system to present said data in a specified format.

10. The method of claim 9, wherein said application container employs JavaBeans™.

11. The method according to claim 1, wherein said method further comprises the step of restricting, via a restricted database component, a retrieval of said data.

12. The method according to claim 11, wherein said step of restricting further comprises restricting the retrieval of a specifiable database.

13. The method according to claim 11, wherein said step of restricting further comprises restricting the retrieval of a specifiable data element.

14. The method according to claim 11, wherein said step of restricting further comprises restricting the retrieval of a row of said data.

15. The method according to claim 11, wherein said step of restricting further comprises restricting the retrieval of a range of rows of said data.

16. A global data dictionary system configured to store a plurality of data elements, each of said data elements corresponding to data elements in one of a plurality of databases, said dictionary system further configured to identify relationships between two or more of said data elements.

17. The system according to claim 16, further comprising retrieval means configured to retrieve data from said databases in response to a user query.

18. The system of claim 16, wherein said dictionary system comprises a data element dictionary configured to store said plurality of data elements and to identify each said database that said data elements are found in.

19. The system of claim 16, wherein said dictionary system further comprises a master keyword dictionary for storing a plurality of keywords, said plurality of keywords comprising a list of every said data element and a group of industry words, each said keyword having a synonym set.

20. The system of claim 19, wherein said synonym set of each said keyword comprises a plurality of words having a relationship with said keyword.

21. The system of claim 20, wherein said plurality of words having a relationship with said keyword comprises a plurality of said data elements.

22. The system of claim 21, wherein said master keyword dictionary maintains a weight for each relationship between a keyword and each word in said keyword's synonym set, said weight corresponding to a measure of similarity between said keyword and each word in said keyword's synonym set.

23. The system of claim 22, wherein said dictionary system further comprises an ambiguity data element dictionary that is configured to store a plurality of ambiguous data elements, said ambiguous data elements comprising data elements from said databases that have the same name as another data element but a different meaning.

24. A method for retrieving data from a plurality of databases, said method comprising the steps of:
storing in a dictionary system a plurality of data elements, each of said data elements corresponding to at least one data element in said plurality of databases;
identifying relationships between two or more of said data elements in said dictionary system;
receiving from a user a request for data in the form of a query data element;
identifying at least one of said data elements in said dictionary system that corresponds to said query data element; and
retrieving corresponding data from each of said identified data elements of said databases corresponding to said query data element.

25. The method of claim 24, further comprising the step of storing said plurality of data elements in a data element dictionary, said data element dictionary configured to identify each said database that said data elements are found in.

26. The method of claim 24, further comprising the step of storing a plurality of keywords in a master keyword dictionary, said plurality of keywords further comprising a list of every said data element, a group of industry words, and each said keyword having a synonym set.

27. The method of claim 26, wherein, in said step of storing said plurality of keywords in said master keyword dictionary, said synonym set of each said keyword comprises a plurality of words having a relationship with said keyword.

28. The method of claim 27, wherein, in said step of storing said plurality of keywords in said master keyword dictionary, said plurality of words having a relationship with said keyword comprises a plurality of said data elements.

29. The method of claim 28, further comprising the step of maintaining, in said master keyword dictionary, a weight for each relationship between a keyword and each word in said keyword's synonym set, said weight corresponding to a measure of similarity between said keyword and each word in said keyword's synonym set.

30. The method of claim 29, further comprising the step of storing, in an ambiguity data element dictionary, a plurality of ambiguous data elements, said ambiguous data elements comprising data elements from said databases that have the same name as another data element but a different meaning.

31. The method of claim 29, further comprising the step of employing an application container to retrieve said data via channels.

32. The method of claim 31, wherein said application container employs a model channel, said model channel configured to retrieve data from a particular data source, and a view channel, said view channel configured to instruct the system to present said data in a specified format.

33. The method of claim 31, wherein said application container employs JavaBeans™.

34. A system for facilitating the retrieval of data from a plurality of databases, comprising:
a dictionary system configured to store a plurality of data elements, each of said data elements corresponding to data elements in one of said plurality of databases, said dictionary system further configured to identify relationships between two or more of said data elements; and
retrieval means configured to retrieve data from said databases in response to a user query.

35. The system of claim 34, wherein said dictionary system comprises a data element dictionary configured to store said plurality of data elements and to identify each said database that said data elements are found in.

36. The system of claim 34, wherein said dictionary system further comprises a master keyword dictionary for storing a plurality of keywords, each said keyword having a synonym set.

37. The system of claim 36, wherein said synonym set of each said keyword comprises a plurality of words having a relationship with said keyword.

38. The system of claim 37, wherein said plurality of words having a relationship with said keyword comprises a plurality of said data elements.

39. The system of claim 38, wherein said master keyword dictionary maintains a weight for each relationship between a keyword and each word in said keyword's synonym set, said weight corresponding to a measure of similarity between said keyword and each word in said keyword's synonym set.

40. The system of claim 39, wherein said dictionary system further comprises an ambiguity data element dictionary that is configured to store a plurality of ambiguous data elements, said ambiguous data elements comprising data elements from said databases that have the same name as another data element but a different meaning.
